(19) United States
(12) Patent Application Publication
(10) Pub. No.: US 2010/0257643 A1
(43) Pub. Date: Oct. 7, 2010

(54) ULTRASOFT ATOMIC FORCE MICROSCOPY DEVICE AND METHOD

(75) Inventors: Ronald Reifenberger, Lafayette, IN (US); Arvind Raman, West Lafayette, IN (US); Laura Butler Biedermann, Albuquerque, NM (US); Mehdi M. Yazdanpanah, Louisville, KY (US)

Correspondence Address: GREER, BURNS & CRAIN, 300 S WACKER DR, 25TH FLOOR, CHICAGO, IL, 60606, US

(73) Assignees: UNIVERSITY OF LOUISVILLE RESEARCH FOUNDATION, INC., Louisville, KY (US); PURDUE RESEARCH FOUNDATION, West Lafayette, IN (US)

(21) Appl. No.: 12/709,118

(22) Filed: Feb. 19, 2010

Related U.S. Application Data
(60) Provisional application No. 61/153,903, filed on Feb. 19, 2009.

(51) Int. Cl. G01Q 60/24

(52) U.S. Cl. 850/6; 850/33

(57) ABSTRACT

A preferred embodiment of the invention provides an ultra-soft atomic force microscope device that has a nanoneedle cantilever that terminates in a smaller diameter nanofiber tip. Deflection of the nanoneedle cantilever is measured directly by a laser Doppler vibrometer. The invention simultaneously provides a very low mass nanoneedle cantilever arm with a very small diameter nanofiber tip, while being able to image the vibration and displacement. An AFM device of the invention simultaneously provides a ultra low mass and soft cantilever, the ability to accurately and directly measure vibration and deflection of the very small diameter nanoneedle cantilever with the laser Doppler vibrometer, and a sharp nanofiber tip that provides sub nanometer resolution.

### PRIORITY CLAIM AND REFERENCE TO RELATED APPLICATION

This application claims priority under 35 U.S.C. §119 from prior provisional application Ser. No. 61/153,903, which was filed Feb. 19, 2009.

### FIELD

A field of the invention is atomic force microscopy. Example preferred applications of the invention include imaging of soft biological samples in liquid. A particular preferred application of the invention is imaging that is capable of resolving individual soft biological macromolecules, e.g., proteins.

### BACKGROUND

Atomic force microscopy (AFM) uses a very small cantilever arm with a sharp tip, called a probe at its end. The tip can be brought proximate or into contact with a sample, and the deflection of the cantilever provides information about the sample. When a tip is brought proximate a sample, various forces can induce deflection prior to actual contact, e.g., van der Waals forces and electrostatic forces. In a typical imaging mode of operation, the tip can be moved with respect to the sample to scan the sample surface. The resolution attained by this type of scanning probe microscopy is orders of magnitude better than the optical diffraction limit, which is a barrier to the resolution of optical based microscopy techniques.

The deflection of the cantilever in a typical AFM microscope is an active subject of research and most commercial AFM microscopes use optical detection to determine the deflection or vibration of the AFM cantilever. Typically, a laser beam is directed at the cantilever arm at an angle and is reflected at an angle toward an optical detector array. When the cantilever arm deflects, the reflected laser spot strikes the array in a different position. More recently, optical interferometers have been proposed to detect beam deflection and vibration. In particular, laser Doppler vibrometers have been used to detect vibration and displacement of conventional AFM cantilevers, most often made of silicon and having a typical dimensions with a length in the range of about 90-460 μm and widths of about 20-50 μm. See, e.g., Ngoi, et al., “Two-Axis-Scanning Laser Doppler Vibrometer for Microstructure,” Optics Communications, Volume 182, Issues 1-3, 1 Aug. 2000, Pages 175-185; Snitka, et al., “AFM based Polarization Nanolithography on PZT Sol-Gel Films,” Microelectronic Engineering, Volume 83, Issues 4-9, April-September 2006, Pages 1456-1459. These techniques have used laser Doppler vibrometers to image standard AFM cantilevers.

Laser Doppler vibrometry uses the Doppler shift of a reflected laser beam from a vibrating object to measure that object's vibrational velocity. Laser Doppler vibrometers have been used in other applications to measure structures with micrometer sized dimensions. Examples include the detection of oscillations in microelectromechanical systems (MEMS) devices such as microcantilevers and rotational oscillators. See, Portoles, et al.“Accurate velocity measurements of AFM-cantilever vibrations by Doppler interferometry,” J. Exp. Nanosci. 1 51-62 (2006); Ricci J, eta al, “Air-coupled acoustic method for testing and evaluation of microscale structures,” Rev. Sci Instrum. 78 055105 (2007). One study also considered the measurement of clamped silicon nanowires with optical interferometery. Belov et al, “Mechanical resonance of clamped silicon nanowires measured by optical interferometry,” J. Appl. Phys. 103 074304 (Apr. 7, 2008).

AFM continues to have limits however. One problem involves sample damage. To avoid sample damage, a feedback mechanism can be used to maintain a constant force between the tip and the sample by adjusting the cantilever height. However, the feedback technique is not effective for very fragile samples, such as soft biological macromolecule samples in liquids. Typical AFM forces in the range of 10 picoNewtons (pN) to 1 nanoNewton (nN) can irreversibly damage such soft biomolecules. In spite of these inherent limitations, researchers have made some progress, developing different AFM techniques to image biological materials with nanometer resolution. However, the imaging forces are still sufficiently large (10 pN to 1 nN) that imaging soft biological macromolecules in their native state under liquids is very difficult. While atomic force microscopy offers the greatest promise of achieving sub-nm resolution imaging capability, a large gap remains between its potential and the capability of current AFM technology for high-resolution imaging of soft biomolecules in their quasi-native state.

### SUMMARY OF THE INVENTION

A preferred embodiment of the invention provides an ultra-soft atomic force microscope device that has a nanoneedle cantilever that terminates in a smaller diameter nanofiber tip. Deflection of the nanoneedle cantilever is detected directly by a laser Doppler vibrometer. The invention simultaneously provides a very low mass nanoneedle cantilever arm with a very small diameter nanofiber tip, while being able to image the vibration and displacement. An AFM device of the invention simultaneously provides a ultra low mass and soft cantilever, the ability to accurately and directly measure vibration and deflection of the very small diameter nanoneedle cantilever with the laser Doppler vibrometer, and a sharp nanofiber tip that provides sub nanometer resolution.

### BRIEF DESCRIPTION OF THE DRAWINGS

FIG. 1 is a schematic perspective view of a preferred embodiment ultra soft atomic force microscope device of the invention;

FIG. 2A-2C are schematic diagrams that illustrate a preferred embodiment method for forming a nanoneedle cantilever;

FIG. 3 is a plot of the vibration spectrum of an example nanoneedle cantilever as measured by a laser Doppler vibrometer in accordance with the atomic force microscope device of FIG. 1; and

FIGS. 4A and 4B is plots of the vibration spectrum and velocity of an example nanoneedle cantilever as measured by a laser Doppler vibrometer in accordance with the atomic force microscope device of FIG. 1.

### DETAILED DESCRIPTION OF THE PREFERRED EMBODIMENTS

The present invention provides an ultra-soft atomic force microscope device that can provide sub picoNewton forces and simultaneously provide sub nanometer resolution. Applications include high-resolution imaging and materials property characterization with sub-nm resolution of biomolecules in buffer solutions, which offers the oppourtunity to greatly advance understanding of the molecular basis of disease and of drug-cell interactions. The sub-nm resolution imaging is important in the study of biophysics in the realms of individual proteins, DNA, lipid bilayers, and viruses supported on surfaces in liquid environments. Such imaging resolution could provide, for example, high-resolution maps of protein markers expressed on a biological membrane, maps of regions on a protein with specific affinity to drug molecules or high resolution material property maps of viruses in quasi-native state.

A preferred embodiment of the invention provides an ultra-soft atomic force microscope device that has a nanoneedle cantilever that terminates in a smaller diameter nanofiber tip. Deflection of the nanoneedle cantilever is detected directly by a laser Doppler vibrometer, i.e. a test beam of the laser Doppler vibrometer is directed at and at least partially reflected by the nanoneedle cantilever. A probe device, such as a conventional atomic force microscope cantilever or can support and move the nanoneedle cantilever. The invention simultaneously provides a very low mass nanoneedle cantilever arm with an ultra small diameter nanofiber tip, while being able to measure the vibration and displacement of the nanoneedle cantilever. An AFM device of the invention simultaneously provides a ultra low mass and soft cantilever, the ability to accurately and directly measure vibration and deflection of the very small diameter nanoneedle cantilever with the laser Doppler vibrometer, and a sharp nanofiber tip that provides sub nanometer resolution. The inventors have demonstrated that the laser Doppler vibrometer can measure deflection and vibration of the nanoneedle cantilever despite the fact that the nanoneedle cantilever can have a diameter that is substantially smaller than the beam waist and beam wavelength. The inventors have demonstrated that imaging is possible with an uncoated Ag₂Ga nanoneedle cantilever having a diameter as small as about 65 nm, but 96 nm nanoneedles provided a stronger response. The nanoneedle cantilever must be sized to be measurable by the laser Doppler vibrometer, but that will depend upon the material of the nanoneedle cantilever. Different materials and coatings can enhance that light scattered by the nanoneedle. As a general principal, material or coatings that provide greater scattering can have a smaller diameter. Assuming the that signal-to-noise ratio (SNR) of the vibrational resonance peak is proportional to the amount of light scattered, the smallest diameter the smallest diameter nanoneedle whose vibration spectra can be measured scatters light at resonance with a SNR of about 1:1.

The nanoneedle cantilever preferably has a substantially constant diameter. For a preferred Ag₂Ga nanoneedle cantilever, tests have showed that an example nanoneedle with a diameter of 60 nm still reflected sufficient light so that its oscillation spectra could be recorded. The ultimate limit of small diameter is reached for a given nanoneedle material and coating (if any) when insufficient light is reflected. The nanofiber tip is in preferred embodiments has a radius in the range of about 5 nm to 10 nm. It is expected that a molecular fiber tip as small as 1 nm can be used. The nanofiber tip should be small enough to accurately measure the given sample with high resolution. The nanoneedle cantilever is preferably attached at a predetermined angle to the end of a standard tipless AFM cantilever, such as a tipless silicon cantilever. A device of invention can image samples, for example soft biological samples in buffer solutions, with sub-picoNewton (pN) forces and sub-nm lateral resolution. An AFM device of the invention also has a high bandwidth, ensuring compatibility with high speed scanners. The small mass of AFM cantilevers of the invention is orders of magnitude less than the mass of conventional AFM cantilevers; thus providing increased resonance frequencies and decreased thermal vibration (amplitude) at low frequencies.

Preferred embodiment ultra-soft devices of the invention include substantially constant diameter Ag₂Ga nanoneedle cantilevers having a 50-500 nm diameter and length to diameter ratio providing a flat frequency response over a large frequency band. The preferred nanoneedle cantilevers have bending stiffness approximately two orders of magnitude softer (k˜10⁻⁴ N/m) and have resonance frequencies that are 1-2 orders of magnitude higher than the softest commercially available cantilevers known to the inventors. Displacement and vibration of the nanoneedle cantilever in an AFM device of the invention is directly and accurately measured using a laser Doppler vibrometer.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale. In the drawings, the same reference numerals may be used to indicate similar elements in different figures.

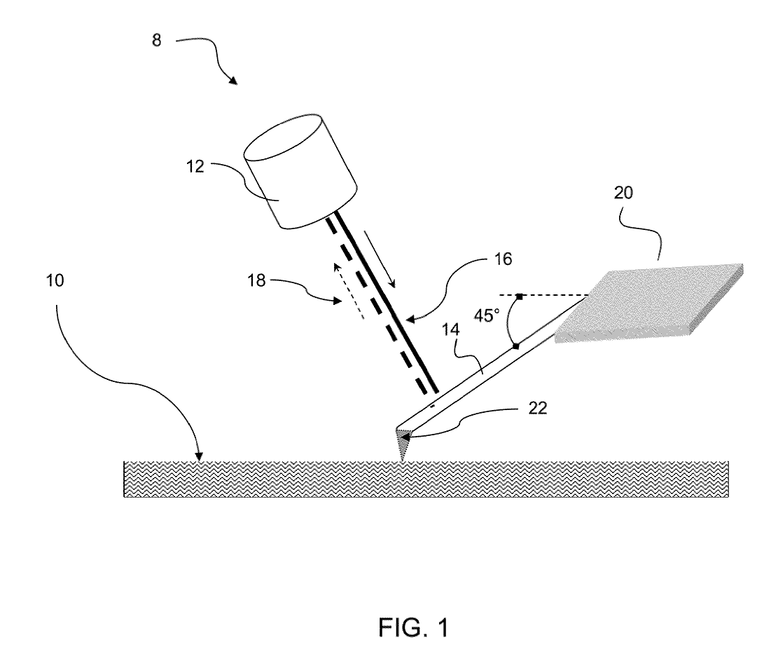

FIG. 1 shows preferred embodiment ultra soft atomic force microscope device 8 of the invention in the process of imaging a sample 10 that is disposed in liquid. The sample 10 is, for example, biological macromolecules such as proteins to be imaged disposed in a liquid buffer. A laser Doppler vibrometer 12 directly detects vibration of a nanoneedle cantilever 14 by subjecting it to a test laser beam 16 and analyzing the frequency or phase difference between a reflected light beam 18 and a an internal reference beam split from the test beam. While air and vacuum imaging is also possible, the liquid buffer is preferred as it reduces the chance of line contact between the nanoneedle cantilever 14 and the sample.

The laser Doppler vibrometer 12 in preferred embodiment scan be a commercial system, such as available from Polytec Inc. The laser Doppler vibrometer 12 includes a processor or provides data to a processor that can develop images of a sample based upon deflection and or vibration of the nanoneedle cantilever. The laser Doppler vibrometer can be aligned with the nanoneedle 14 by ensuring that the nanoneedle 14 is normal to the test laser beam 16. Alignment can be accomplished by relative rotation between the nanoneedle 14 and the laser Doppler vibrometer so that the entire length of the nanoneedle 14 is in focus in the laser Doppler vibormeter's optical microscope (the focal depth of a typical 50× lens is 3.2 μm). In experiments, the laser beam was aligned using a CCD camera coupled to the optical microscope that was used to focus the laser beam onto the nanowire. Typical commercial laser Doppler vibrometers also include 2D alignment functions, which can be used to align the test beam with the nanoneedle cantilever 14. Observation of the diffracted laser beam also permits reproducible alignment. The nanoneedle cantilever 14 is attached a predetermined angle, preferably 45°, to a conventional tipped or tipless AFM cantilever or other probe device 20, such as a silicon cantilever. The predetermined angle should substantially exceed 10°, to help minimize the chance of line contact. The nanoneedle cantilever 14 terminates in a nanofiber tip 22. With a preferred embodiment substantially constant diameter Ag₂Ga nanoneedle cantilever 14 having a 100-500 nm diameter and a length of 1-100 μm, a bending stiffness approximately two orders of magnitude softer (k˜10⁻⁴ N/m) and have resonance frequencies that are 1-2 orders of magnitude higher than the softest commercially available cantilevers known to the inventors can be achieved. Preferred embodiments in accordance with FIG. 1 can provide imaging forces of less than 1 pN. The nanofiber tip 22, which can be formed from a polymerization of monomers or oligimers, can provide a sharp tip having sub nanometer resolution. Additional nanofiber tips can be formed by capillary thinning activity between the nanoneedle cantilever and another liquid containing material for the tip, such as soft molecules that are biologically compatible. The ultrasoft image probe operation provided by the preferred embodiment device 8 is capable of imaging biological macromolecules in the liquid sample 10 as illustrate in FIG. 1.

Sensing can be conducted by measuring either the deflection or velocity of a nanoneedle cantilever as a function of time as it is moved in a raster fashion across a sample. If the deflection (or velocity) changes with time, it follows that a force has been exerted on the end of the nanoneedle, since the force is proportional to the acceleration by Newton's first Law. The acceleration can be calculated from the 2^{nd} derivative of the deflection vs. time data or the 1st derivative of the velocity vs. time data. The typical AFM scan modes can be used, including non-contact, continuous contact, intermittent contact and jump contact. For the imaging of biological samples, the continuous contact and jump contact modes are likely to provide the best results.

The device 8 simultaneously provides a ultra low mass and soft cantilever 14, the ability to accurately image the very small diameter cantilever 14 with the laser Doppler vibrometer 12, and a sharp tip 22 that provides sub nanometer resolution. The inventors have demonstrated that the laser Doppler vibrometer can measure deflection and vibration of the nanocantilever 14 despite the fact that the nanocantilever can have a diameter that is substantially smaller than the beam waist and beam wavelength of the laser Doppler vibrometer. A typical test beam for a laser Doppler vibrometer has wavelength of 630 nm, and the inventors have demonstrated, that imaging is possible with a nanoneedle cantilever having a diameter as small as about 100 nm.

Preferred embodiment devices in accordance with FIG. 1 provide a nanoneedle cantilever mass that is 6 orders of magnitude smaller than that of conventional cantilevers. The hydrodynamic cross-section of the nanoneedle cantilever 14 can be 4 orders of, magnitude less than commercial cantilevers ensuring greatly reduced hydrodynamic forces. The nanoneedle cantilever stiffness (10⁻⁴ N/m) can be 1-2 orders of magnitude smaller than the softest conventional AFM probes (10⁻²-10⁻³ N/m). The nanoneedle cantilever resonance frequency in liquids (50-100 kHz) can be 1-2 orders of magnitude greater than of conventional soft AFM cantilevers (1-10 kHz). The nanofiber tip 22 can be made sharp and can have selected to have a particular chemical composition to probe specific biomolecules of interest. Preferred Ag₂Ga nanoneedle cantilevers are inherently electrically conducting, so the AFM device 8 can also probe electrical currents generated by mechanical deformation. Imaging forces with the AFM device 8 can be less than 1 pN, thereby allowing for a two-orders-of-magnitude reduction in imaging forces—and, consequently, lateral resolution—compared to current AFM technology. Moreover, the high resonance frequency ensures that the technology has high bandwidth and can be integrated into high-speed AFM controllers.

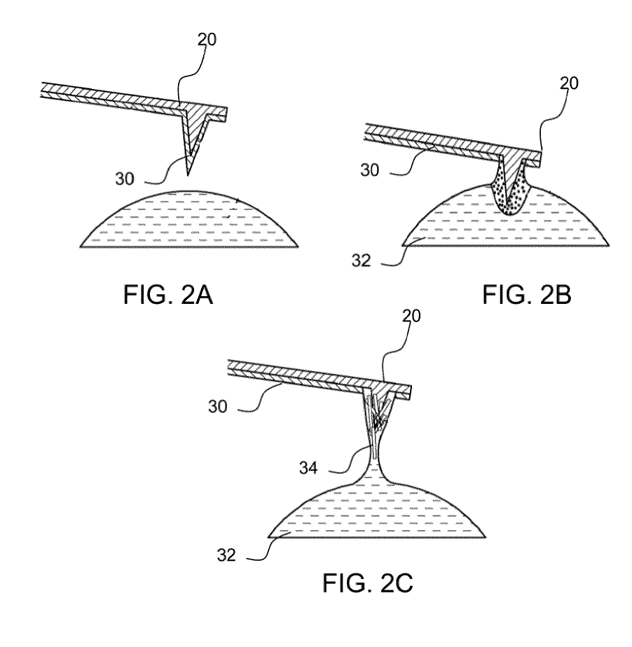

FIG. 2A-2C illustrates a preferred method for forming a nanoneedle cantilever. In FIG. 2A a tipped or tipless AFM cantilever or other probe device 20 is coated with a thin film of metal, e.g. silver 30, such as by sputter coating. In FIG. 2A the AFM cantilever 20 is brought into contact with and dipped inside a drop of metal that will form an alloy, e.g., gallium (Ga) 32 with the coating. In FIG. 2C, the AFM cantilever 20 is retracted from the Ga droplet 32 parallel to the direction of the desired nanoneedle cantilever that will form. A meniscus is formed between the cantilever 20 and the Ga droplet 32. As the cantilever 20 is retracted from the droplet 32 at a slow rate, an Ag₂Ga nanoneedle cantilever 34 is formed within the meniscus, and is oriented along the direction of the meniscus. Pulling the cantilever farther from the droplet enables the nanoneedle cantilever to grow longer. Eventually, the nanoneedle snaps free from the gallium droplet 32. The time required for the nanoneedles to form ranges from a few seconds to a few minutes depending upon the length of the nanoneedle that will be formed. In the case of Ag₂Ga nanoneedles, the nanoneedles form at room temperature. Additional details, materials, and structures for forming the required nanoneedle or arrays of nanoneedles to act as a cantilever in devices of the invention are disclosed in Cohn et al., U.S. Published Application No. 2009-0082216-A1, published on. Mar. 26, 2009, entitled Metallic Nanostructures, Self-Assembly, and Testing Methods, which is incorporated by reference herein.

After formation of the nanoneedle cantilever 14, a nanofiber tip can be formed on the end of the cantilever by dipping the nanoneedle into a moleclular solution or a polymer solution. A nanofiber forms as the nanoneedle cantilever 14 is pulled from the molecular or polymer solution to form the nanofiber tip 22 at the end of the nanoneedle cantilever 14. For biological systems, it is helpful to have tips made of soft molecules (e.g., peptides, proteins, biocompatible polymer, etc.) that are chemically and mechanically tunable. A molecular tip is formed on a nanoneedle cantilever using a micromanipulator to dip the nanoneedle cantilver into a liquid buffer containing the desired molecules to form a stable meniscus between the nanoneedle cantilever and the liquid surface. The nanoneedle cantilever is then pulled away from the liquid to stretch and eventually break the meniscus. An ultra-sharp molecular tip is formed from the portion of molecules left on the nanoneedle cantilever after the meniscus breaks. An ideal molecular tip could be as sharp as 1 nm and as long as 500 nm. The molecular tip should be selected of a material that is mechanically stable and that will dissolve in the intended imaging environment.

After formation of a nanoneedle cantilever, the laser Doppler vibrometer 12 can be used to directly measure the vibrational spectra of the nanoneedle cantilever 14. By measuring various nanoneedle cantilevers with different length-to-width ratios, data about the elastic modulus and spring constant for a nanoneedle cantilever of a given length, diameter, and material can be determined. From the measured resonance spectrum and using Euler beam theory, the elastic modulus and the spring constant of each nanocantilever is calculated using geometrical information provided from parallel SEM studies of the nanoneedle cantilever's dimensions.

In experiments conducted in accordance with the method of FIGS. 2A-2C to fabricate Ag₂Ga nanoneedle cantilevers, an Ag coat was formed on an AFM cantilever (e.g., PPP-SEIHR from Nanoscience Instruments). A preliminary step coats the cantilever with a thin layer of Cr (10 to 20 nm) as an adhesive layer, followed by the coating of an Ag layer (50 to 200 nm). The silver coated cantilever is then brought into close proximity to a sub 100 μm Ga droplet, using a PiezoPatch™ Micromanipulator (PPM5000) from World Precision Instrument (WPI). The cantilever is then dipped into a gallium droplet and after a few seconds pulled away from the droplet to form an Ag₂Ga nanoneedle cantilever. The process can be observed with a 3D optical microscope, equipped with three separate high magnification/long distance lenses—one for the top view and two for the side views. Nanoneedle cantilevers can easily be seen under optical microscopes, because they are crystalline with smooth facets.

Several nanoneedle cantilevers 14 ranging from 5 to 50 μm long and 65 to 500 nm in diameter were fabricated using this technique. The nanoneedle cantilevers were fabricated both on contact-mode and non-contact-mode commercially available AFM cantilevers. It was demonstrated that the length and diameter of the nanoneedle cantilevers can be controlled by the thickness of silver layer coating (between 50 and 200 nm), the temperature of formation (between 25 and 80° C.), and the time permitted for reaction, i.e. the time that the silver layer is kept inside the gallium droplet and the time to pull the nanoneedle cantilever from the gallium droplet.

Preferred nanofiber tips 22 are formed from fibrinogen molecules, which polymerize to form fibrin polymer nanofiber tips. A fibrin molecular tip is made from fibrinogen protein (commercially available from American Diagnostica, Stamford, Conn.). A crosslinking agent factor XIIIa (320 KDa) is mixed into the fibrinogen solution immediately before the nanoneedle cantilever is dipped into the solution. Before dipping, the nanoneedle cantilever 14 is coated with a thrombin solution (a polymerization initiator). Thrombin initiates the polymerization of fibrinogen locally at the tip of the nanoneedle cantilever enabling formation of a very small and sharp fibrin molecular tip. Other polymeric solutions such as PMMA [Poly(methyl methacrylate)] in chlorobenzene and PEO (polyethylene oxide) in water can similar be used with an appropriate initiator coating on the nanoneedle cantilever to form the desired nanofiber polymer. Solvent temperature, polymer type and concentration, and pulling rate control the fiber formation.

The laser Doppler vibrometer 12 can include an optical microscope in the signal leg to facilitate spot placement on the nanoneedle cantilever 14. The velocity of the vibrating object Doppler shifts the back scatted light by an amount Δ(t) proportional to the reverse wave length of the laser λ, frequency f and amplitude A(t) of the oscillating object according to:

Δ(t)=4 πf×A(t)/λ

The backscattered beam recombines with a reference beam to form an interference signal that is decoded and Fourier transformed to yield the vibration oscillation spectra of interest. The minimum detectable displacement or velocity is limited by the noise floor of the laser Doppler vibrometer.

The beam waist and wavelength of the laser beam (λ≈630 nm) are larger than the nanoneedle cantilever diameter, d. Under these conditions, the incident light is scattered according to Mie theory, which predicts in the limit d<<λ that the scattering scales as d 3λ³. How rapidly the scattering approaches zero as d decreases is an important issue.

When d is comparable to λ, a Mie scattering efficiency should be calculated. Mie scattering predicts an enhancement of the reflected light. How big an enhancement depends on the optical constants of the nanowire, the wavelength of the laser light and the length and/or diameter of the nanowire. The reflected light can be optimized using Mie scattering which takes into account the optical constants and geometry of the nanoneedle. The size of enhancement depends on the optical constants of the nanoneedle, the wavelength of the laser light and the diameter of the nanoneedle. In Mie theory, the scattering cross section per unit length of the cylinder, C_{sca}, depends on the diameter of the cylinder dₒ, the complex index of refraction of both the cylinder (N) and surrounding medium (N_{med}), and the wavelength (λ) and angle of incidence of the light beam. See, e.g., Craig F. Bohren and Donald R. Human, “Absorption and Scattering of Light by Small Particles,”. John Wiley & Sons, New York, 1983; C. F. Bohren, “Scattering of electromagnetic-waves by an optically-active cylinder,”Journal of Colloid and Interface Science, 66(1):105-109 (1978). Example calculations by some of the inventors are presented for carbon nanotubes in Biedermann et al, “Flexural Vibration Spectra of Carbon Nanotubes Measured Using Laser Doppler vibrometry,” Nanotechnology 20 (2009) 035702 (6 pp) (which publication is incorporated by reference herein). By dividing the scattering cross section by the projected geometric cross-sectional area per unit length of the nanoneedle cantilever, a dimensionless quantity Q_{sca} can be obtained that is useful in characterizing the scattered radiation field. If Q_{sca} is greater than 1, then light is effectively scattered from an apparent object that is larger in cross-section than the actual scattering cylinder. If Q_{sca} is too small, then any scattered light will likely fall below the noise floor of the laser Doppler vibrometer producing no measurable signal. For a given nanoneedle material (or coating on a nanoneedle), this limit will define the smallest cross section that be effectively measured.

Mie calculations of Q_{sca} using the optical properties of Ag₂Ga were conducted to understand how Q_{sca} scales with the nanoneedle cantilever's diameter d. Various diameters (from 65 to 500 nm) of Ag₂Ga nanoneedle cantilevers were fabricated to determine the optimum diameter. Because these nanoneedle cantilevers are single crystalline with atomically flat facets, the laser reflection should be substantial even for diameters as small as 100 nm. Even if a higher diameter is required, by tuning the length of the nano-cantilever (from 1 to 100 μm) it is feasible to still keep the spring constant of the nano-cantilevers around 10′−4 N/m with a resonance frequency of 100 kHz or higher.

During imaging it is important to avoid making a line contact with the sample, which can occur if the nanocantilever snaps into the sample under van der Waals forces. With the invention, because the nanoneedle cantilever can be set at a desired angle, this possibility can be minimized. Generally, the angle should be substantially larger than 10 degress, which is the small angle where line contact is likely to occur. Preferably, the nanoneedle-cantilever can be oriented to be approximately 45° to the sample surface, which promotes contact between the sample and the nonfiber tip while avoid sample and nanoneedle contact. The ultra sharp nanofiber tip also avoids contact problems, as does conducting imaging of samples that are imaged in liquid environments where the adhesive forces are reduced. To image a sample, the nanofiber tip can be scanned across a sample while a constant force is maintained, and a topographic image of the sample will be produced by the laser Doppler vibrometer.

Force displacement testing curves of example nanoneedle cantilevers 14 showed that the critical buckling force of an example nanoneedle cantilever (which was 157 nm in diameter and 15 μm in length) can be as high as 160 nN. The Young's modulus of the example nanoneedle cantilever was calculated to be about 68.3 GPa. Additional testing measured and calculated quality factor (Q), spring constant and Young's modulus, which showed the nanoneedle cantilevers have high Q (as high as 3500) in vacuum, and a Young's modulus of approximately 70 GPa. For an example nanoneedle of 100 nm in diameter and 20 micrometer in length, the spring constant would be as low as 0.0001 N/m, while the resonance frequency would be as high as 100 kHz. Theoretical calculations of the thermal fluctuations of the nanoneedle cantilever in a liquid indicate that fluctuations due to Brownian motion are sufficiently small to allow the detection of sub-picoNewton forces.

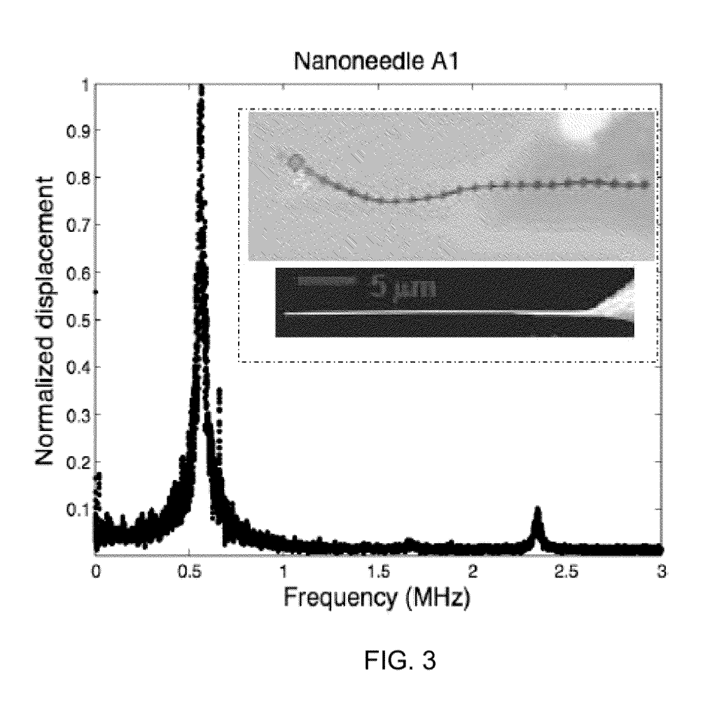

The results of an experiment are illustrated in FIG. 3, which shows the vibration spectrum of an Ag₂Ga nanoneedle cantilever measured with the laser Doppler vibrometer. The bottom inset is an SEM image of the nanoneedle cantilever grown on the end of a conventional AFM cantilever that used to obtain the plot in FIG. 3, and the top inset is the 2^{nd} eigenmode of another nanoneedle cantilever measured using the laser Doppler vibrometer operated at 1.45 MHz. In the top inset, the measured eigenmode is superimposed over an optical image of a nanoneedle cantilever under deflection. In the plot of FIG. 3, well defined peaks at the first and second bending eigenmodes can be seen. The nano-cantilever is 22 μm long and 240 nm thick. From the measured resonant frequencies, Young's modulus is estimated to be ˜76 GPa. Using this result, an accurate estimate for the stiffness of 0.003 N/m can be obtained. Remarkably, the signal to noise ratio of motion measurement is high enough that by scanning the laser Doppler vibrometer laser test spot over the nanoneedle cantilever, it is possible to map out the spatial eigenmode as shown in the upper inset for the second eigenmode of a different longer Ag₂Ga nano-cantilever.

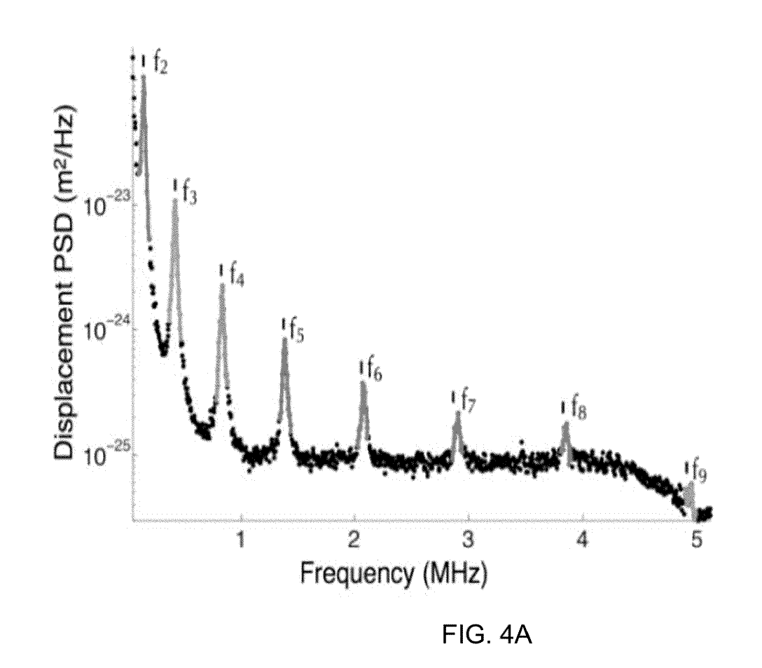

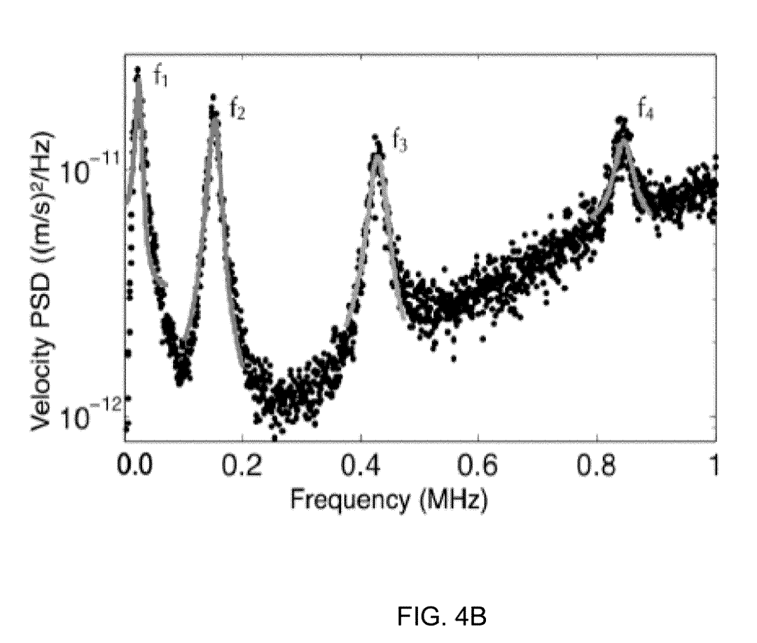

FIGS. 4A and 4B shows the result of another experiment that demonstrates the ability of the laser Doppler vibormeter to measure the vibration of a nanoneedle cantilever. Specifically, FIGS. 4A and 4B depicts the vibration spectrum and velocity spectrum as measured by a Laser Doppler Vibrometer of a 60 micrometer long and 206 nm diameter Ag₂Ga nanoneedle cantilever that was grown on a tungsten probe. The data shows that 9 harmonic modes are detected, demonstrating the excellent laser reflectivity of the metallic nanoneedle cantilever. From the vibration spectrum, Young's modulus is measured to be 84 GPa±1 GPa. For a nanoneedle of 100 nm in diameter and 20 micrometer in length, the spring constant would be as low as 0.0001 N/m, while the resonance frequency would be as high as 100 KHz. These results demonstrate that Ag₂Ga nanoneedles can detected directly by the laser Doppler vibrometer and used as ultra-sensitive nano-cantilevers for sub-picoNewton force measurement during AFM scanning. Other nanoneedles were also tested. The smallest Ag₂Ga nanoneedle tested was 65 nm in diameter and 22 μm long. Eight nanoneedles were tested on AFM cantilevers and tungsten probe tips with diameters ranging from 65-300 nm and lengths of 4-60 μm. The nanoneedles are faceted and provided good scattering. Nanoneedles having a length to diameter ratio providing a flat frequency response over a large frequency band are preferred. Example relatively short nanoneedles, one having a length of 4.3 μm, diameter of 96 nm and the other having a length of 6.2 μm and diameter of 106 nm, showed a flat frequency response below ˜1 MHz, and their spring constant was ˜0.01 N/m.

Data from eight example Ag₂Ga nanoneedles that were tested in experiments is show in Tables 1 and 2 below. Table 2 shows The measured eigenfrequencies of needle NNB from Table 1 and mean square displacements of the 1^{st}-9th eigenmodes, as determined from both the velocity and displacement spectra.

TABLE 1

| | | Diameter | |
|---|---|---|---|
| Designation | Length (μm) | (nm) | Comments |
| NNA | 23 & 30 | 115 & 194 | two conjoined nanoneedles of |
| | | | unequal diameter and length |
| NNB | 60 | 206 | long, straight nanoneedle |
| NNC | 9.6 | 163 | short, stiff nanoneedles |
| NND | 4.3 | 96 | flat frequency response <2 MHz |
| NNE | 6.2 | 106 | flat frequency response <1 MHz |
| NNF | 22 | 65 | very soft cantilever (k_{c}~10⁻⁵) |
| NNG | 10 | 301 | high Q₁ = 50 in atmosphere |
| NNB2 | 16.6 & 17 | 140 | two conjoined nanoneedles of |
| | | | nearly equal diameter and length |

TABLE 2

| | | Measured frequencies | | | | Areas of peaks | | |
|---|---|---|---|---|---|---|---|---|
| | fⱼ | | | | K_{eq. freq}^{j} | (zⱼ²) | K_{eq. area}^{j} | |
| j | (MHz) | fⱼ/f₂ | (αⱼ/α₂)² | % error | (N/m) | (nm²) | (N/m) | γⱼ |

Values measured from N N B's velocity spectra

| | | | | | | | | |
|---|---|---|---|---|---|---|---|---|
| 1 | 0.0256 | — | — | — | 1.2 × 10⁻⁴ | 32 | 1.27 × 10⁻⁴ | 0.83 |
| 2 | 0.153 | 1.000 | 1.000 | 0 | 0.0041 | 0.67 | 0.0060 | 0.69 |
| 3 | 0.423 | 2.809 | 2.800 | 0.30 | 0.033 | 0.079 | 0.052 | 0.63 |
| 4 | 0.846 | 5.528 | 5.486 | 0.76 | 0.13 | 0.033 | 0.12 | 1.0 |

Values measured from N N B's displacement spectra

| | | | | | | | | |
|---|---|---|---|---|---|---|---|---|
| 2 | 0.152 | 1.000 | 1.000 | 0 | 0.0042 | 0.84 | 0.0048 | 0.84 |
| 3 | 0.428 | 2.822 | 2.800 | 0.78 | 0.032 | 0.10 | 0.041 | 0.80 |
| 4 | 0.838 | 5.528 | 5.486 | 0.77 | 0.12 | 0.024 | 0.017 | 0.74 |
| 5 | 1.388 | 9.156 | 9.070 | 0.94 | 0.34 | 0.0098 | 0.41 | 0.82 |
| 6 | 2.079 | 13.71 | 13.55 | 1.2 | 0.76 | 0.0054 | 0.75 | 1.0 |
| 7 | 2.900 | 19.13 | 18.93 | 1.1 | 1.2 | 0.0036 | 1.1 | 1.3 |
| 8 | 3.846 | 25.37 | 25.20 | 0.69 | 2.6 | 0.0032 | 1.3 | 2.1 |
| 9 | 4.938 | 33.57 | 32.36 | 0.65 | 4.3 | 0.0011 | 3.8 | 1.1 |

Artisans will appreciate that ultrasoft AFM microscopy with a device of the invention can be used in many important applications. Example applications include high-resolution imaging of cell membranes, viruses, proteins, DNA, and biological molecules. Other applications include the mapping specific protein binding/expression sites on cells. AFM microscopy conducted with a device of the invention can also be used to measure forces between biomolecules, for the validation of therapautic drugs, for protein conformation, cancer research, and DNA sequencing.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An ultrasoft atomic force microscopy device, the device comprising:
a nanoneedle cantilever attached to a probe device;
a nanofiber tip disposed at the end of said nanoneedle cantilever; and
a laser Doppler vibrometer disposed to directly detect deflection and/or vibration of said nanoneedle cantilever.

2. The device of claim 1, wherein said nanoneedle cantilever has a diameter that is substantially smaller than a beam waist of a test beam of said laser Doppler vibrometer.

3. The device of claim 1, wherein said nanoneedle cantilever has a substantially constant diameter.

4. The device of claim 3, wherein the substantially constant diameter of said nanoneedle cantilever is in the range of about 50 nm to 500 nm.

5. The device of claim 4, wherein said nanoneedle cantilever has a length in the range of about 1 μm to 100 μm.

6. The device of claim 5, wherein said nanofiber tip has a radius in the range of about 1 nm to 10 nm.

7. The device of claim 6, wherein said nanoneedle cantilever is conductive.

8. The device of claim 3, wherein said nanoneedle cantilever is attached to said probe device at a predetermined angle that substantially exceeds 10°.

9. The device of claim 8, wherein the predetermined angle is about 45°.

10. The device of claim 3, wherein said nanofiber tip comprises a polymer nanofiber.

11. The device of claim 10, wherein said nanofiber tip comprises biologically compatible polymer.

12. The device of claim 11, wherein said biologically compatible polymer comprises polymerized Fibrinogen.

13. The device of claim 3, wherein said nanofiber tip comprises soft molecules.

14. The device of claim 3, wherein said nanoneedle cantilever comprises a metal alloy.

15. The device of claim 13, wherein said nanoneedle cantilever comprises Ag₂Ga.

16. The device of claim 1, wherein the probe device comprises a tipped or tipless conventional atomic force microscope and said nanoneedle cantilever is attached to a cantilever of the tipped or tipless conventional atomic force microscope.

17. The device of claim 1, wherein said nanoneedle cantilever has a length to diameter ratio that provides a flat frequency response over a desired frequency range.

18. A method for ultra soft atomic force microscopy, the method comprising:
contacting a sample with the end of a nanofiber tip supported by a nanoneedle cantilever; and
measuring deflection and/or vibration of the nanoneedle cantilever with a laser Doppler vibrometer having a test beam directed at said nanoneedle cantilever.

19. The method of claim 18, wherein said sample comprises a biological molecule disposed in a liquid.

20. The method of claim 18, wherein said contacting comprises scanning the sample with the end of the nanofiber tip in a contact mode.
